(19) United States
(12) Patent Application Publication
(10) Pub. No.: US 2008/0300803 A1
(43) Pub. Date: Dec. 4, 2008

(54) Leak detection system and method

(76) Inventors: David A. Drake, Escondido, CA (US); Gregory M. Quist, Escondido, CA (US)

Correspondence Address: NATH & ASSOCIATES, 112 South West Street, Alexandria, VA, 22314, US

(21) Appl. No.: 12/153,969

(22) Filed: May 29, 2008

Related U.S. Application Data
(60) Provisional application No. 60/932,074, filed on May 29, 2007.

(51) Int. Cl. G01M 3/04

(52) U.S. Cl. 702/51

(57) ABSTRACT

Systems and methods are disclosed that facilitate the detection of leaks in a pressured pipe. The system includes one or a plurality of pressure sensors, placed at one or several locations along the pipe, and a power source providing power to the one or plurality of pressure sensors. Also a computing device, a communications device, and an algorithm is included. The algorithm assesses data received from the communications device, the data containing information from the one or plurality of pressure sensor(s), wherein the algorithm determines the presence of a pressure leak in the pressurized pipe based on a first pressure profile versus a second pressure profile.

### CROSS-REFERENCE

This is a Non-Provisional Application of U.S. Provisional Patent Application Ser. No.: 60/932,074, filed on May 29, 2007, the entire content of which is hereby incorporated by reference in its entirety.

### BACKGROUND

I. Field

This disclosure is related to leak detection. More particularly, this disclosure is related to leak detection for pressurized systems.

II. Background

Leak detection is important for several reasons, including for example loss of potable water from pressurized delivery lines and spills caused by pressurized sewage lines. Traditional methods of leak detection rely upon visual inspection of lines and evidence of leaks around the pipes, such as visible moisture, sink holes, smells from sewage spills, decreased water flow at the end point of the pipe, etc. Severe sewage spills indicate the need for a rapid assessment of pipe integrity and leakage from holes or cracks in pipes.

In view of the above needs, the present disclosure describes novel systems and methods to rapidly detect leaks in pressurized lines such that the existence, location, and severity of these leaks can be immediately relayed to appropriate authorities, thus minimizing the environmental and economic consequences of the leak.

### SUMMARY

The foregoing needs are met, to a great extent, by the present disclosure, wherein systems and methods are provided that in some embodiments facilitate a detection of leaks in a pressured pipe, comprising: one or a plurality of pressure sensors, placed at one or several locations along the pipe; a power source providing power to the one or plurality of pressure sensors; a computer; a communications device; and an algorithm to assess data received from the communications device, the data containing information from the one or plurality of pressure sensor(s), wherein the algorithm determines the presence of a pressure leak in the pressurized pipe based on a first pressure profile versus a second pressure profile.

### BRIEF DESCRIPTION OF THE FIGURES

FIG. 1 shows a schematic layout according to an embodiment of the disclosure.

FIG. 2 shows an example of pressure profiles.

FIG. 3 shows an example of pressure profiles during periods of pumping.

FIG. 4 shows a diagram of a leak detection assessment according to an embodiment of the disclosure.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principals described are not to be limited to a single embodiment, but may be expanded for use with any of the other methods and systems described herein as will be understood by one of ordinary skill in the art unless otherwise stated specifically.

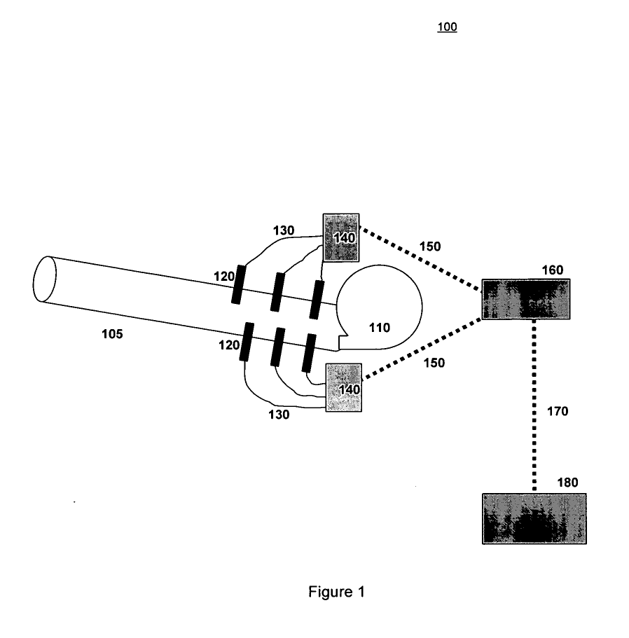

FIG. 1 shows a schematic diagram 100 according to an embodiment of the present subject matter. A pressurized pipe 105, which could be a water line or sewer line, or other type of transmission line including oil or gas, carries liquid under pressure through the pipe 105. A pump 110 (or also a series of pumps) provides pressure at one end of the pipe to force the liquid through the pipe 105. One or a multiple of pressure sensors 120 are placed at various positions along the pipe 105, contact the liquid in the pipe 105 either directly or through a pressure-loss free connector, and continuously or periodically measure instantaneous pressure in the pipe 105. The locations may be along the pipe, around the pipe, or both, and may create a functional form of location that optimizes the pattern recognition measurements from the sensors 120. Each pressure sensor 120 is has a communications connection 130 (wired or wireless) to an instrumentation unit 140. While FIG. 1 shows communications connection 130 in a wired configuration, the present disclosure also contemplate the communication connection in a wireless configuration. The instrumentation unit 140 may contain some or all of the following items: a power supply; a (micro)processor; an analog to digital (A/D) converter; a digital clock; a two-way wireless communications means such as a pager; cell phone or other communications device; software; environmental packaging (e.g. NEMA 6P) and communications ports. Of course, more or less items may be part of the instrument unit 140, according to design preference.

In certain embodiments, this instrumentation unit 140 has a power supply which for example without limitation may be a replaceable primary battery, as a non-limiting example, a lithium thionyl chloride battery package with long shelf life, connected to a separate environmental enclosure that contains the power electronics, the microprocessor, the A/D converter, and the wireless radio. The battery package may also be environmental, and may include circuitry that limits rapid discharge of the batteries in order to minimize or eliminate sparks if the battery is short-circuited, and may also include “smart-battery” circuitry that continuously measures the effective discharge of the battery package and enables the lifetime of the batteries to be determined externally and remotely. The connection between the battery package and the electronics enclosure may be achieved through a rugged waterproof connector, typically one that is used, for example, in the automobile industry. Other power sources may also be AC power, solar power, fuel cells, electromechanical power sources, or other power supplies.

Referring again to FIG. 1, data collection, data processing, and two-data communications processing takes place in the instrumentation unit 140. Communications means 150 is a two-way link between instrumentation unit 140 and a larger, more global communications network 160, which may be a wireless network such as a cell phone or two-way pager network. Communications means 170 is a two-way link between the communications network 160 and a local communications device 180 that typically would sit with a user, for example, a cell phone, two way pager, personal data assistant (PDA), personal computer, or other capable one way or two way communications devices.

The communications means 150 and 170 may comprise any form of wireless or wired communication protocol, device, mechanism, system, and so forth. Thus, digital and/or analog transmissions can be used via the communications means 15 and 170 according the design implementation. Depending on the resources available to the managing entity, various frequencies (either singly or multiply) may be used for communication information between the instrumentation unit 140, communications network 160 and local communications device 180.

Instrumentation unit 140 may operate in one or more of several modes. A first mode is an “alarm” mode, in which the microprocessor in the instrumentation unit 140 makes a determination that the pressure profile from the single or multiple sensors has generated a unique signature indicating that a leak has occurred. In this mode, an alarm is sent through wired or wireless means 150 to a communications network 160, which then further processes the data, for example determining the location from where the alarm originated and to where the alarm is to be sent, and sends this data via wired or wireless means 170 to a local two-way communications device 180 that allows the action to be taken to respond to a leak.

It should be noted that the communications network 160 may be connected to the Internet or other network resource. Similarly, the communications device 180 may be connected to the Internet or other network resource. Connection to the communications network 160 and communications device 180 may also be facilitated via a host or local server, according to design implementation. In this instance, the server may act as a central server and may parse information from the various devices attached to the network. Based on the “type” of device communicating to the server, the server may forward different status or different priority messages or use a different communication means to forward information to the communications device 180. Accordingly, information warranting a rapid response may be sent via a page, versus information that does not require a rapid response, for example.

In certain embodiments, the instrumentation unit 140 sends messages though a two-way paging network 150, such as those operated by Skytel (Clinton, Mo.), USA Mobility (Plano, Tex.) or Space Data (Chandler, Ariz.), as non-limiting examples of commercial/private providers, to a dedicated server 160, which sends data through the internet to portable devices 180 such as pagers, cell phones, PDAs, and so forth, and also posts this data on a secure web site to be viewed by users of the system, in which the communications devices 180 are computers with Internet access.

A second mode is a “reporting” mode, in which pressure data is taken on a periodic basis from each of the pressure sensors 120 and stored in the instrumentation unit 140. On a periodic basis, the instrumentation unit 140 spontaneously transmits the stored data through communication means 150 to the communications network 160 and finally through communications means 170, to a user communications device 180.

A third mode is a “control” mode in which commands may be sent in the “reverse” direction from communications device 180 through the communications means 170 and network 160 to instrumentation unit 140. These commands are processed by the microprocessor in instrumentation unit 140 and cause the instrumentation unit to modify some aspect of operations.

Examples of a control mode could include, without limitation: turning sensors on or off; changing the frequency at which the sensors take pressure measurements; changing the internal operating software of the instrumentation unit; changing the frequency at which the instrumentation package sends historical data; changing the algorithms that determine if a leak has occurred; and changing the content of the data that is sent from the instrumentation unit periodically.

A fourth mode is a “maintenance” mode in which maintenance data representing environmental parameters such as, for example, temperature and humidity or operating parameters of the system, including, for example, pressure sensor 120 operations, power supply voltage, communications level (e.g. received signal strength indicator); and other diagnostic operation parameters are sent from the instrumentation unit 140 to the user communication device 180 on either an alarm basis or a periodic basis.

A fifth mode is a “request” mode in which a user, through the communications device 180, may request current pressure, environmental, operational performance and/or maintenance parameter values or other data in the “reverse” direction through communications means 170 to the communications network 160, through another communications means 150, finally to the instrumentation unit 140. Software in the instrumentation unit 140 can cause a real-time measurement of requested parameters and sends the results immediately back through the communications means to the data collection/reception device 180.

Since indication that a leak has occurred or is occurring is one of the most important aspects, the means by which a leak is detected is a critical part in addressing this issue. Two cases are considered: a static case in which the fluid in the pipe is quiescent (not pumped), and a second in which the fluid in the pipe is experiencing normal or typical pumping conditions.

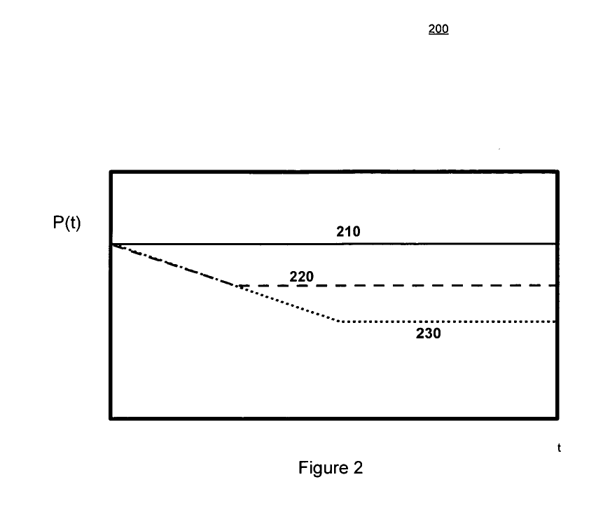

FIG. 2 shows an example 200 of data generated by pressure sensors in a quiescent condition that may be used by instrumentation unit 140 to process pressure data received to make a determination that a leak has occurred in a pressurized pipe, such as a force main in a sewer system. Consider pressured pipe 105 in FIG. 1 that has a natural upward slope from the pump 110. If the pump 110 were turned off for a period of time, the pressure as a function of time can be measured at various locations along the pipe, generating a graph 200 like that shown in FIG. 2.

A pressure profile like that shown in 210 in FIG. 2 indicates that there are no leaks, as the static pressure in the pipe stays constant over time. Pressure profiles 220 and 230 could occur is there is a leak along the section of the pipe between the pressure sensors and the top of the pipe. In the case of pressure profile 200, a leak is farther from the pressure sensors and higher on the pipe than a leak indicated by pressure profile 300. By combining measurements from several pressure sensors, a small leak at a specific location can be identified. In addition, in some embodiments when the pumps are turned off, an active acoustic signal can be generated, and the signal analyzed using methods listed below to determine whether or not a leak exists in the pipe.

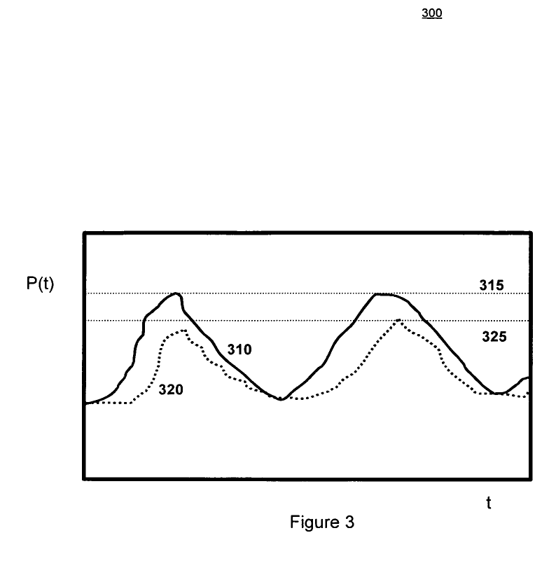

FIG. 3 shows an example 300 of data generated by a pressure sensor at a specific location on a pressurized pipe during periods of pumping. Curve 310 corresponds to an example of how the pressure may vary over time under normal operating conditions, with no leak in the pipe. The maximum pressure is indicated by the horizontal line 315. Under leak conditions, a pipe will not be able to maintain the same pressure profile, and the leak will manifest itself in a pressure profile signature that is different than normal operating conditions. This signature will vary depending upon the location of the pressure sensor, the location of the leak, the pump(s) operational performance, and the hydrodynamic details of the pipe and hole causing the leak. As one simple example, the maximum pressure would drop under a leak condition. For example, curve 320 corresponds to a leak condition as measured by a pressure sensor. In this case, the curve has a somewhat different profile, but most markedly, does not have the same maximum value 325 as the non-leaking case.

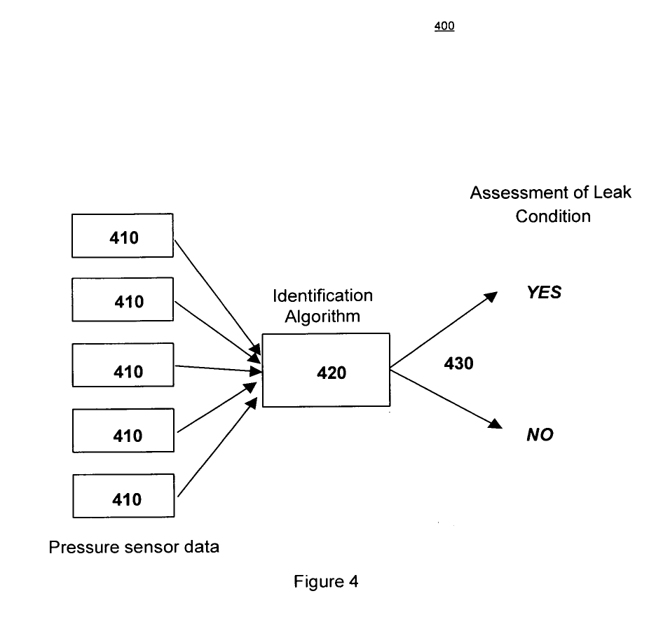

FIG. 4 shows a schematic diagram 400 of how certain embodiments use multiple pressure sensors to make a decision about whether or not a leak is present. The pressure sensors 120, per FIG. 1, are placed at various locations along the pipe 105. Baseline (normal, non-leak) measurements are made to determine the “pressure signature” of the pipe 105 as a function of time, operating parameters and location along the pipe. The variability of these signatures is captured in the data collected by sensors 410 in FIG. 4. When a leak occurs, it creates a signature that is determined by the algorithm 420 to be significantly different enough from the baseline that an alarm is generated 460 and sent to a user, per the system shown in FIG. 1. Various signal processing and pattern recognition techniques can be applied to this problem, including, but not limited to the following:
Least mean squares
Analysis of Variance (ANOVA)
Multiple analysis of variance (MANOVA)
Matched filter(s)
Numenta
Neural networks
Bayesian analysis
Rules engine
Fourier/frequency analysis
Kalman filtering
Hamming filtering
Auto-correlation
Cross-correlation
Heuristic algorithms

Analysis of the dynamic pressure conditions may also include contemporary data collected directly from the pumps used to pressurize the pipe, in order to minimize false positives and increase the fidelity of the decision-making process. Optimization of an applicable algorithm can be performed to reduce the number of false positives or false negatives.

It should therefore be appreciated that given the teachings provided herein, one of ordinary skill may be able to monitor the integrity of a sealed transport systems, such as pressurized pipes, for example. As such, methods and systems have been disclosed that enable the described embodiments to be applicable for fluid conveying systems as well as gas conveying systems, or a combination of the two. Also, while the context of the embodiments are described in terms of pipes, other vessels or conveying constructs may be used according to design preference. It should also be noted that while FIGS. 2-3 shown a certain pressure “profile,” other profiles may be relevant according to design.

Additionally, the methods and systems may be implemented by various devices. For example, the identification algorithm 420 of FIG. 4 may be processed by a computer or hardware or analogy thereof. Stand alone or distributed systems may be configured. Single or multiple types of processing engines may be used, such as application specific integrated circuits (ASICS), digital signal processors (DSPs), programmable logic devices (PLDs), microcontrollers, microprocessors and other forms of electronic or electrical devices capable of operating as a decision or execution engine. Further, networking of such systems or hardware may be envisioned according to design implementation. In some embodiments, software for operation of the exemplary methods and systems may be integrated into the hardware platform, or may be distributed. Accordingly, serial or parallel or a combination of the two, including neural or cloud computing approaches may be used. Thus, communication between various aspects of the embodiments described herein may be hardwired or wireless, or combinations of the two.

Additionally, each or several of the various elements of the embodiments described may be contained in an environmentally secure enclosure. In some instances, the embodiments may have selective elements within the enclosure and selective elements outside the enclosure. For example, the pressure sensors may be exterior to the enclosure while the instrumentation unit 140 and/or the communications means 150 may be interior to the enclosure, for example. Thus, elements that need to be protected can be protected via the environmental enclosure.

As varied as the hardware implementation can be, modifications or variations of the software algorithm 420 may be similarly performed without departing from the spirit and scope. Therefore, improvements to or combinations of the listed signal processing and pattern recognition techniques may be used, according to design implementation. As the listed techniques are not intended to exhaustive, but to illustrate the breath of applicable techniques, other techniques not described herein can also be used.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to detect leaks in a pressured pipe, comprising:
one or a plurality of pressure sensors, placed at one or several locations along the pipe;
a power source providing power to the one or plurality of pressure sensors;
a computer;
a communications device; and
an algorithm to assess data received from the communications device, the data containing information from the one or plurality of pressure sensor(s), wherein the algorithm determines the presence of a pressure leak in the pressurized pipe based on a first pressure profile versus a second pressure profile.

2. The system according to claim 1, wherein the pressure sensors acts in at least one of two modes:
a passive “listening” mode; and
an active mode,
wherein acoustic signals are generated and a return is measured.

3. The system according to claim 1, wherein the pressure sensors are placed in any one or more of along the pipe, around the pipe, and in locations that are determined by a pattern recognition analysis to be optimal in terms of minimizing false positives and minimizing false negatives.

4. The system according to claim 1, wherein the computer is a microprocessor or embedded processor.

5. The system according to claim 1, wherein the computer, power source, and communications device are all packaged together in an environmentally secure enclosure.

6. The system according to claim 1, wherein the power source is a battery.

7. The system according to claim 1, wherein the communications device provides wireless communication.

8. The system according to claim 7, wherein the communications device provides two-way digital paging.

9. The system according to claim 7, wherein the communications device operates in at least one of VHF and UHF.

10. The system according to claim 7, wherein the communications device is a cell phone.

11. The system according to claim 7, wherein the communications device includes a first communications means to a central server, and second a second communications means from the central server to a two-way communications device.

12. The system according to claim 1 1, wherein which the central server parses information coming from the computer to uniquely identify the computer, the unique identification being used to determine a routing means to the two-way communications device.

13. The system according to claim 1, wherein, in which the system may operate in one of several modes.

14. The system according to claim 13, wherein one of the several modes is an alarm mode in which the computer generates an alarm based on an algorithm operating in the computer.

15. The system according to claim 14, wherein the algorithms is based on signal processing and pattern recognition techniques, including at least one or more of:
least mean squares;
analysis of variance (ANOVA);
multiple analysis of variance (MANOVA);
matched filters;
Numenta;
neural networks;
Bayesian analysis;
rules engine;
Fourier/frequency analysis;
Kalman filtering;
Hamming filtering;
auto-correlation;
cross-correlation; and
heuristic algorithms.

16. The system according to claim 15, wherein input data to the algorithm includes data from a pressure source creating pressure in the pipe.

17. The system according to claim 13, wherein a mode is reporting mode in which data recorded is reported periodically though the communications device.

18. The system according to claim 13, wherein a mode is a control mode, in which commands are sent to the computer, interpreted by the computer and executed by the computer.

19. The system according to claim 17, wherein commands may comprise one or more of:
turning sensors on or off;
changing software in the computer;
altering a frequency of sending historical data;
changing a leak detection algorithm;
changing a frequency at which the sensors make pressure measurement; and
changing content of periodically sent data.

20. The system according to claim 13, wherein a mode is a maintenance mode, wherein data regarding operational parameters is sent either periodically or spontaneously from the computer through the communications device.

21. The system according to claim 13, wherein a mode is a request mode, wherein a command is sent to the computer and the computer interprets this command and a current pressure, environmental, operational performance and/or maintenance parameter value(s) or other data is returned through the communications device.
